(19) United States
(12) Patent Application Publication
(10) Pub. No.: US 2008/0302010 A1
(43) Pub. Date: Dec. 11, 2008

(54) Channeling for Hydroponic or Similar Cultivations

(76) Inventor: Joan REPISO CORDON, Barcelona (ES)

Correspondence Address: STURM & FIX LLP, 206 SIXTH AVENUE, SUITE 1213, DES MOINES, IA, 50309-4076, US

(21) Appl. No.: 12/134,582

(22) Filed: Jun. 6, 2008

(30) Foreign Application Priority Data
Jun. 7, 2007 (ES) ES 1065781

(51) Int. Cl. A01G 31/02

(52) U.S. Cl. 47/59 R; 47/62 R

(57) ABSTRACT

An improved channeling for hydroponic or similar cultivations, being of the type that is made up of a plurality of gutter shaped channelings that have a shape that is noticeably “U” shaped, said portions of channeling being connected to each other by means of some fixing means that are arranged at the ends of same, and are basically characterized by the fact that the fixing means have a coupling piece made of a semi-rigid mouldable plastic material made by injection with a shape that is appreciably “U” shaped that coincides with the profile of the portion of the channeling, there being an inner lateral wall and a second outer lateral wall on the outside of the first so that there is a groove between the two lateral walls which will be used for the insertion of the portion of channeling, there also being a perpendicular separation wall along the complete perimeter inside said groove, and comprising some means of fitting by pressure that overlaps the outer lateral wall of the coupling piece that are for the coupling of the lateral wall of the portion of the channeling in a fixed manner.

### CROSS REFERENCE TO RELATED APPLICATIONS

This application claims priority of Application No. ES 200701221 filed Jun. 7, 2007, which is incorporated by reference herein in its entirety.

### DESCRIPTIVE MEMORANDUM

### Aim of the Invention

The aim of this present is a channeling for an improved hydroponic or similar cultivation that includes outstanding innovations and advantages compared to other channelings with the same purpose that are known in the current state of the art.

More specifically, the invention makes reference to an improved channeling for hydroponic cultivations of the type that is made up of a plurality of portions of gutter shaped channeling with a general “U” shape, said portions of the gutter channeling being joined to each other by means of some method of fixing fitted at the ends of same in such a way as to guarantee a watertight and reliable join.

### BACKGROUND OF THE INVENTION

In order to carry out the hydroponic type of cultivation, currently containers or portions of channeling of differing shapes are normally arranged in a way in which they are slightly raised from the ground level by means of some supports, and which are joined to each other defining a channeling where the plants are placed without earth and making the water drainage easier. This type of cultivation, as it is well known has numerous advantages, such as the fact that it improves the yield compared to cultivations in traditional earth as it allows quicker growth, a reduction of the costs, control against pests and other harmful agents in addition to guaranteeing that the plant has the necessary nutrients and water for its suitable growth.

In the specific case of using portions of channeling, these can be joined to each other at the ends by means of fixing in such a way as to enable a hydroponic channeling to be obtained with the length that is required. However, the fixing methods known in the current state of the art do not guarantee the water tightness and fixing as and how would be desired, hence there is still the need to solve said disadvantages.

In addition, in none of the fixing means known to the applicant for this type of recipient is the existence considered of an invention that has the characteristics that are described in the attached claims.

### DESCRIPTION OF THE INVENTION

The present invention has been developed for the purpose of providing a channeling for hydroponic or similar cultivations that solves the above-mentioned disadvantages, in addition contributing other additional advantages that will become clear from the description that is given below.

It is for this reason that the aim of the invention is to provide an improved channeling for hydroponic or similar cultivations, being of the type that is made up of a plurality of gutter shaped channelings that have a shape that is noticeably “U” shaped, said portions of channeling being connected to each other by means of some fixing means that are arranged at the ends of same, and are basically characterized by the fact that the fixing means have a coupling piece made of a semi-rigid mouldable plastic material made by injection with a shape that is appreciably “U” shaped that coincides with the profile of the portion of the channeling, there being an inner lateral wall and a second outer lateral wall on the outside of the first so that there is a groove between the two lateral walls which will be used for the insertion of the portion of channeling, there also being a perpendicular separation wall along the complete perimeter inside said groove, and comprising some means of fitting by pressure that overlaps the outer lateral wall of the coupling piece that are for the coupling of the lateral wall of the portion of the channeling in a fixed manner.

Thanks to these characteristics, a fixing system is achieved for the formation of channelings for hydroponic cultivation by means of a single simply constructed piece and with low manufacturing cost that in addition guarantees good fastening between the different pieces of the channeling and, at the same time, provides a good feature of water tightness for the passage of the fluids on the inside of said channeling. Another advantage to be highlighted of the channeling being described here is the easy assembly of the pieces that make up the channeling for the hydroponic cultivation, in turn making the maintenance and replacement of damaged parts easier.

In accordance with another aspect of the invention, the pressure fitting means are made by a plurality of portions that protrude in two opposite directions corresponding to the two portions of adjacent channeling, each one of the protruding portions having a central hollow portion and a gripping tab overlapping section from the inner part of said portion.

Advantageously, the previously mentioned coupling piece has some means of water tightness, said means of water tightness being thoric seals located in the grooves defined between the two lateral walls.

In accordance with another characteristic of the invention, the upper edge of each one of the lateral walls of the portion of the channeling has a stretch that protrudes made up of a junction box that includes an open section and an inverted “U” shaped extension that protrudes towards the outside intended for the insertion of a clamp. In this way the portions of channeling can be supported in the air in an easy and simple manner, allowing an increase of the free space on the inside of an enclosure for the hydroponic cultivation so as to carry out other functions or increase the working surface area and without the need to use supports or groups of shelves specifically designed to support the channelings.

The outer face of the lateral walls of the portion of the channeling is provided with protruding sections whose sizes coincide with the central open portion so as to be able to fit into said central open portion when fixing said coupling piece.

Other characteristics and advantages of the improved hydroponic cultivation channeling object of this present invention will become clear from a description of a preferred embodiment, but it is not exclusive, the drawings that are attached are by way of illustration but without being in any way limiting.

### BRIEF DESCRIPTION OF THE DRAWINGS

FIG. 1. Shows a perspective view of a partial stretch of channeling for the hydroponic or similar cultivation that is in accordance with the present invention;

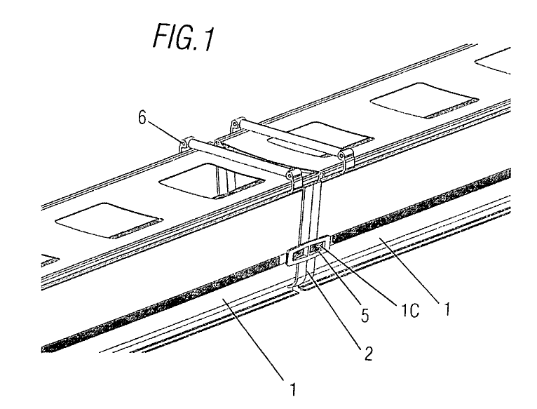

FIG. 2. Shows a detailed view in partial perspective of the channeling in accordance with the invention;

FIG. 3. Shows the coupling piece that includes the fixing mechanism; and

FIG. 4. Shows a transverse section view of the channeling for the hydroponic cultivation of the invention.

### DESCRIPTION OF A PREFERRED EMBODIMENT

In view of the figures attached here, an embodiment of the channeling for the improved hydroponic cultivation is made up of a plurality of portions of channeling (1) which has a shape that is appreciably “U” shaped from an extruded plastic material and with a predetermined length, said portions of channeling (1) being joined to each other by fixing means fitted at the ends of same and that are described below. The lateral walls of the portion of channeling (1) are slightly inclined outwards when compared to the vertical axis (10) so as to make their stacking easier during the transporting and storage operations after their manufacture.

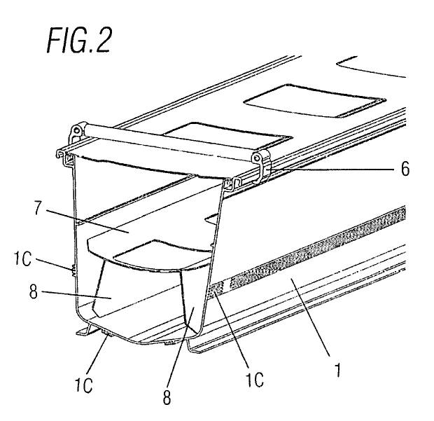

As it can be seen in greater detail in FIG. 2, said means of fixing are made up of a coupling device (2) made of a semi-rigid plastic material that is mouldable by injection that has an appreciably “U” shape that coincides with the profile of the portion of the channeling (1), an inner lateral wall (2A) having been provided and a more exterior second lateral wall (2B) so that there is a groove (3) that is formed between both lateral walls (2A,2B) intended for the insertion of the portion of the channeling (1), there also being a separation wall (4) located in a perpendicular manner along the entire length inside of said groove (3). The coupling piece (2) also comprises a means of pressure fitting (5) with a certain degree of flexibility that overlap the outer lateral wall of the coupling piece (2) intended to fit into the lateral wall of the portion of channeling (1) in a fixed manner.

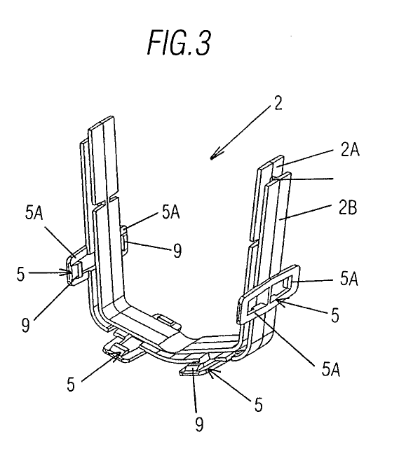

As it can be seen in FIG. 3, the pressure fitting means (5) are formed by a plurality of protruding portions (5A) that extend in two opposite directions corresponding to two portions of adjacent channeling, each one of the protruding portions (5A) having a hollow central rectangular portion and overlapping the inner part of said protruding portions (5A) is a gripping tab (9) that ensures the fixing when being assembled.

In an additional manner, the coupling piece (2) has some means of water tightness that are made up of a pair of thoric seals (not shown) located in the groove (3) placed between the two lateral walls (2A,2B), which face each other and separated from each other by the inner separation wall (4).

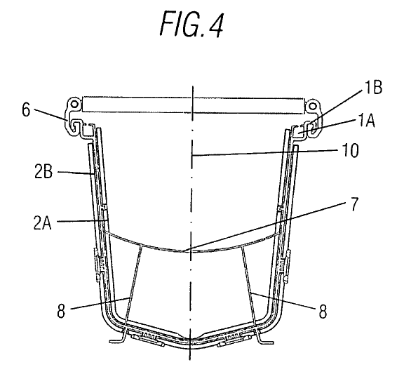

The upper edge of each one of the lateral walls of the portion of the channeling (1) has a protruding stretch made basically of a connection box (1A) that has an open stretch and an extension (1B) in the form of an inverted “U” or hook that overlaps outwardly intended for the insertion of a clamp (6) to keep the channeling supported in the air (because of this having the previously stated advantages), said protruding stretch (1B) being designed in such a way that it makes the unwanted release of the clamp (6) difficult (Shown with greater clarity in FIG. 4). This is due to the fact that the greater the weight to be supported by the channeling, the greater the force of pressure and hold exercised bringing some small facing portions closer together that define the connection box (1A).

The outer face of the lateral walls likewise the base of the portion of the channeling (1) is provided with protruding sections (1C) in the form of vanes whose general sizes coincide with the central open portion of the protruding portions (5A) so as to be able to fit into said central open portion when fixing said coupling piece (2).

On the inside of the channeling of the present embodiment, as and how can be seen in FIGS. 2 and 4, there is a support tray (7) included which has a plastic nature and is a detachable type that rests longitudinally on the base of the channeling by means of the help of two feet (8) that overlap in a downward direction and which are formed in a joint manner with the body of the tray itself, said support tray (7) defining two clearly separated areas, a first upper area where the substrate of the plant is housed, such as an artificial substrate made up of perlite, coco fibre, etc. and a second lower area that acts as a drainage channeling where the water circulates.

The details, shapes, sizes and other accessorial elements, likewise the materials used in the manufacture of the channeling for the improved hydroponic cultivation of the invention can be appropriately substituted by others that are technically equivalent and do not stay away from the essentiality of the invention or the scope defined by the claims that are included below.

1. Improved channeling for hydroponic or similar cultivations, of the type comprising a plurality of gutter shaped channelings that have a shape that is noticeably “U” shaped, said portions of channeling being connected to each other by fixing means that are arranged at the ends of same, wherein the fixing means comprise a coupling piece made of a semi-rigid mouldable plastic material made by injection with a shape that is appreciably “U” shaped that coincides with the profile of the portion of the channeling, there being provided an inner lateral wall and a second outer lateral wall on the outside of the first so that there is a groove between the two lateral walls which will be used for the insertion of the portion of channeling, there also being a perpendicular separation wall along the complete perimeter inside said groove, and comprising some means of fitting by pressure that overlaps the outer lateral wall of the coupling piece that are for the coupling of the lateral wall of the portion of the channeling in a fixed manner.

2. Channeling for improved hydroponic or similar cultivation according to claim 1, wherein the means of fitting by pressure of the coupling piece are formed by a plurality of protruding portions that extend in two opposing directions corresponding to two portions of the adjacent channeling, each one of the protruding portions having a central hollow portion and a gripping tab overlapping section from the inner part of said portion.

3. Channeling for improved hydroponic or similar cultivation according to claim 1, wherein the coupling piece has some means for water tightness.

4. Channeling for improved hydroponic or similar cultivation according to claim 3, wherein the said means for water tightness consist of thoric seals located in the groove defined between the two lateral walls.

5. Channeling for improved hydroponic or similar cultivation according to claim 1, wherein the upper edge of each one of the lateral walls of the portion of the channeling has a stretch that protrudes made up of a junction box that includes an open section and an inverted “U” shaped extension that protrudes towards the outside intended for the insertion of a clamp.

6. Channeling for improved hydroponic or similar cultivation according to claim 1, wherein the outer face of the lateral walls and the base of the portion of the channeling is provided with protruding sections whose sizes coincide with the central open portion of the pressure fitting means so as to be able to fit into said central open portion a fixing of the coupling piece.
